(19) United States
(12) Patent Application Publication
(10) Pub. No.: US 2025/0343606 A1
(43) Pub. Date: Nov. 6, 2025

(54) SYSTEM AND METHOD FOR MULTIMEDIA COMMUNICATION USING HUMAN BODY AS A MEDIUM

(71) Applicant: Quasistatics Inc., West Lafayette, IN (US)

(72) Inventors: Shreyas Sen, West Lafayette, IN (US); Shovan Maity, West Lafayette, IN (US)

(21) Appl. No.: 18/655,403

(22) Filed: May 6, 2024

(51) Int. Cl. H04B 13/00

(52) U.S. Cl. CPC H04B 13/005

(57) ABSTRACT

The present invention relates to a system and method for audio, video and data communication using the human body or any other medium as a channel using techniques which benefits from the presence of the human body or the medium. The system comprises a transmitter and a receiver that communicate with each other by utilizing the properties of the human body to enhance signal strength and data rate. The frequencies used for communication may range from 0.1-200 MHz and may employ a variety of modulation schemes, including pulse-based, spread-spectrum, time-domain, and amplitude, phase, and frequency modulation. The communication may be digital or analog and may use single or multi-bit/symbol modulation. The system provides for efficient, secure, and reliable communication that does not require line-of-sight transmission or the use of traditional communication channels. The system finds applications in various fields, including, but not limited to healthcare, military, and entertainment industries.

### TECHNICAL FIELD

Embodiments of the present disclosure generally relates to wearable devices and technologies, and more particularly relates to a system and method for enabling multimedia communication through the human body as a medium.

### BACKGROUND

Current multimedia communication systems rely on traditional wireless communication technologies that are often limited by range and quality of signals. In many situations, such as in noisy environments or in areas with weak signals, audio/video communication may be difficult or even impossible. Moreover, traditional wireless communication may be disrupted by interference from other devices, causing further disruptions in the quality of communication.

Traditional wireless communication technologies may be susceptible to interference from other electronic devices operating on similar frequencies, as well as physical obstacles like buildings or terrain. This interference may degrade signal quality and reduce the reliability of communication. Wireless networks may be highly vulnerable to security breaches. Traditional wireless communication networks may be subject to eavesdropping, unauthorized access, and other security threats if not properly secured with encryption, authentication, and other protective measures. The range of wireless communication is limited by factors such as signal strength, transmission power, and environmental conditions. Traditional wireless communication technologies may have compatibility issues, making it challenging to integrate devices from different manufacturers or operating on different standards which may lead to interoperability problems and limit the flexibility of wireless systems.

Further, constant efforts in reducing the size of unit computing has led to growth of wearable sensors and computing devices, such as fitness trackers and smartwatches. This leads to the human body being transformed into a platform of interconnected smart devices, fundamentally impacting, and improving individuals' well-being. However, achieving seamless communication among these on-body devices presents a crucial challenge.

Generally, wearable devices generate a wealth of personal data, forming a veritable “Human Intranet.” This information holds immense potential for secure transmission to other individuals or machines (“Human Internet”) for various purposes, including personal health monitoring, secure authentication, and data-driven insights.

Traditionally, on-body devices communicate through WBANs, which utilize radio frequency (RF) transmissions. However, HBC emerges as a strong contender due to its inherent advantages. By leveraging the human body's conductive properties, HBC facilitates ultra-low power (ULP) data transfer with significantly lower losses compared to RF propagation in air. Moreover, HBC's confined signal path within the body enhances security by minimizing the risk of eavesdropping, unlike WBANs' susceptible wireless signals.

Despite its benefits, HBC faces a critical challenge: the human body exhibits antenna-like behavior at the FM frequency band. This phenomenon significantly hinders high-speed ULP HBC implementation. Existing solutions, such as adaptive frequency hopping (AFH) and fixed narrowband signaling, attempt to circumvent interference but lack efficient suppression mechanisms. This results in energy-inefficient implementations and the need for bulky filters, ultimately limiting the technology's full potential. Given the significant advantages of HBC, overcoming the FM antenna effect is crucial to unlock its true potential for high-speed, ULP, and secure communication in the emerging landscape of interconnected wearable devices.

Therefore, there is a need in the art to provide a system and method for enabling multimedia communication through the human body as a medium to address the aforementioned deficiencies in the art.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a system for enabling multimedia communication through a human body as medium. The system includes a wearable device for communicating multimedia data through the human body as medium. The wearable device includes a processor and a memory coupled to the processor. The memory comprises processor-executable instructions, which on execution, cause the processor to execute a sequence of tasks. The processor is configured to receive a request for transmitting a multimedia data file to a proximal device using a conductive surface. Further, the processor is configured to generate Electric Quasistatic (EQS) fields between the wearable device and the conductive surface and between the conductive surface and the proximal device. The EQS fields remain contained near the conductive surface and induce current in the proximal device. The processor is further configured to create a communication channel for high-speed data transfer with the proximal device using the generated EQS fields. Further, the processor is configured to determine communication properties of the conductive surface for transmission of the multimedia data file to the proximal device and convert the transmitted multimedia data file to an optimized multimedia data file by applying the determined communication properties to the transmitted multimedia data file. Thereafter, the processor is configured to transmit the optimized multimedia data file to the proximal device via the conductive surface using one or more communication techniques and one or more modulation schemes. The optimized multimedia data files are transmitted over the created communication channel.

Another aspect of the present disclosure includes a method for enabling multimedia communication through the human body as a medium. The method includes receiving, by a processor, a request for transmitting a multimedia data file to a proximal device using a conductive surface. Further, the method includes generating, by the processor, Electric Quasistatic (EQS) fields between the wearable device and the conductive surface and between the conductive surface and the proximal device. The EQS fields remain contained near the conductive surface and induce current in the proximal device. Further, the method includes creating, by the processor, a communication channel for high-speed data transfer with the proximal device using the generated EQS fields. Thereafter, the method includes determining, by the processor, communication properties of the conductive surface for transmission of the multimedia data file to the proximal device. In the end, the method includes converting, by the processor, the transmitted multimedia data file to an optimized multimedia data file by applying the determined communication properties to the transmitted multimedia data file and transmitting, by the processor, the optimized multimedia data file to the proximal device via the conductive surface using one or more communication techniques and one or more modulation schemes. The optimized multimedia data files are transmitted over the created communication channel.

Yet another aspect of the present disclosure provides a non-transitory computer-readable medium comprising machine-readable instructions that are executable by a processor to enable multimedia communication through the human body as a medium. The request for transmitting a multimedia data file to a proximal device using a conductive surface is received and Electric Quasistatic (EQS) fields between the wearable device and the conductive surface and between the conductive surface and the proximal device are generated. The EQS fields remain contained near the conductive surface and induce current in the proximal device. A communication channel for high-speed data transfer with the proximal device using the generated EQS fields is created and communication properties of the conductive surface for transmission of the multimedia data file to the proximal device are determined. Further, the transmitted multimedia data file is converted to an optimized multimedia data file by applying the determined communication properties to the transmitted multimedia data file and then the optimized multimedia data file is transmitted to the proximal device via the conductive surface using one or more communication techniques and one or more modulation schemes. The optimized multimedia data files are transmitted over the created communication channel.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1 illustrates an example network architecture for implementing a computing device for enabling multimedia communication through the human body as a medium, in accordance with an embodiment of the present disclosure.

FIG. 2 illustrates an example block diagram of the system, such as those shown in FIG. 1, for enabling multimedia communication through the human body as a medium, in accordance with an embodiment of the present disclosure.

FIG. 3 illustrates an example flow diagram depicting a method for enabling multimedia communication through the human body as a medium, in accordance with an embodiment of the present disclosure.

FIG. 4 illustrates an example computer system in which or with which embodiments of the present disclosure may be implemented.

FIG. 5A-5D illustrate circuit diagram representations of human body acting as a communication medium for enabling multimedia communication between at least two devices, in accordance with an embodiment of the present disclosure.

FIGS. 6A and 6B illustrates exemplary schematic representation of a Human Body Aided Audio/Video Communication System, including transmitter and receiver configuration, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client, or server, or computer-implemented system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Embodiments described herein provide a system and method for enabling multimedia communication through the human body as a medium. The system that is a wearable device includes a processor and a memory coupled to the processor. The memory comprises processor-executable instructions, which on execution, cause the processor to receive a request for transmitting a multimedia data file to a proximal device using a conductive surface. The processor is further configured to generate Electric Quasistatic (EQS) fields between the wearable device and the conductive surface and between the conductive surface and the proximal device. The conductive surface includes at least one of a human body and a living matter and the proximal device includes at least one of a wearable device, a handheld device, an augmented reality device, and an earphones. The EQS fields remain contained near the conductive surface and induce current in the proximal device. The processor is configured to create a communication channel for high-speed data transfer with the proximal device using the generated EQS fields and determine communication properties of the conductive surface for transmission of the multimedia data file to the proximal device. The communication properties include at least one of a signal strength, a signal quality, a channel capacity, and a data rate. The system is then configured to convert the transmitted multimedia data file to an optimized multimedia data file by applying the determined communication properties to the transmitted multimedia data file. For converting the transmitted multimedia data file to the optimized multimedia data file by applying the determined communication properties to the transmitted multimedia data file, the system is configured for performing at least one of amplifying a signal strength of the transmitted multimedia data file to generate the optimized multimedia data file using at least one of a capacitive termination, a high impedance termination, an air gap termination, a non-100-Ohm termination in conjunction with the human body and then amplifying a channel capacity of the created communication channel in the 0.1-200 MHz frequency range. Further, the processor is configured to transmit the optimized multimedia data file to the proximal device via the conductive surface using one or more communication techniques which benefits due to the presence of conductive surface or the human body, including but not limited to Electro QuasiStatic Human Body Communication, Body Resonance communication and one or more modulation schemes. The optimized multimedia data files are transmitted over the created communication channel. The one or more communication techniques includes at least one of a pulse-based communication, spread-spectrum communication, carrier frequency hopping, time-domain communication, a digital communication and an analog communication and the one or more modulation schemes comprise one of a single bit/symbol, a multi-bit/symbol comprising an orthogonal multiplexing, an amplitude modulation, a phase modulation, and a frequency modulation scheme. In an aspect, wearable device operates in a frequency range of 0.1-200 MHz or more using at least one of a broadband communication, a wideband communication, and a narrowband communication.

In another embodiment, a method for enabling multimedia communication through the human body as a medium is disclosed. The method includes receiving, by a processor, a request for transmitting a multimedia data file to a proximal device using a conductive surface. The conductive surface comprises at least one of a human body and a living matter. Further, the method includes generating, by the processor, Electric Quasistatic (EQS) fields between the wearable device and the conductive surface and between the conductive surface and the proximal device. The proximal device comprises at least one of a wearable device, a handheld device, an augmented reality device, and an earphones. The EQS fields remain contained near the conductive surface and induce current in the proximal device. The method further includes creating, by the processor, a communication channel for high-speed data transfer with the proximal device using the generated EQS fields. Further, the method includes determining, by the processor, communication properties of the conductive surface for transmission of the multimedia data file to the proximal device. The communication properties include at least one of a signal strength, a signal quality, a channel capacity, and a data rate. Further, the method includes converting, by the processor, the transmitted multimedia data file to an optimized multimedia data file by applying the determined communication properties to the transmitted multimedia data file and then transmitting, by the processor, the optimized multimedia data file to the proximal device via the conductive surface using one or more communication techniques and one or more modulation schemes. The one or more communication techniques comprise at least one of a pulse-based communication, spread-spectrum communication, carrier frequency hopping, time-domain communication, digital and an analog communication. The optimized multimedia data files are transmitted over the created communication channel. In converting the transmitted multimedia data file to the optimized multimedia data file by applying the determined communication properties to the transmitted multimedia data file, the method includes performing at least one of amplifying a signal strength of the transmitted multimedia data file to generate the optimized multimedia data file using at least one of a capacitive termination, a high impedance termination, an air gap termination, a non-100-Ohm termination in conjunction with the human body and then amplifying a channel capacity of the created communication channel. The wearable device operates in a frequency range of 0.1-200 MHz or more higher frequency using at least one of a broadband communication, a wideband communication, and a narrowband communication. The one or more modulation schemes comprise one of a single bit/symbol, a multi-bit/symbol comprising an orthogonal multiplexing, an amplitude modulation, a phase modulation, and a frequency modulation scheme.

In another embodiment, a non-transitory computer-readable medium comprising machine-readable instructions that are executable by a processor is disclosed. The processor receives a request for transmitting a multimedia data file to a proximal device using a conductive surface and generates Electric Quasistatic (EQS) fields between the wearable device and the conductive surface and between the conductive surface and the proximal device. The EQS fields remain contained near the conductive surface and induce current in the proximal device. The processor then creates a communication channel for high-speed data transfer with the proximal device using the generated EQS fields and then determines communication properties of the conductive surface for transmission of the multimedia data file to the proximal device. The processor then converts the transmitted multimedia data file to an optimized multimedia data file by applying the determined communication properties to the transmitted multimedia data file. In the end, the processor transmits the optimized multimedia data file to the proximal device via the conductive surface using one or more communication techniques and one or more modulation schemes. The optimized multimedia data files are transmitted over the created communication channel.

In another embodiment, a communication system is disclosed. The communication system includes a first wearable device for transmitting a multimedia data file to a second wearable device via the conductive surface. The conductive surface is configured for converting the transmitted multimedia data file to an optimized multimedia file using one or more communication properties of the conductive surface and forwarding the optimized multimedia file to the second wearable device. The second wearable device is communicatively coupled to the first wearable device via the conductive surface. The second wearable device is configured to receive the optimized multimedia file. The one or more communication properties includes a signal strength, a signal quality, a channel capacity, and a data rate while the conductive surface includes at least one of a human body, and a living matter.

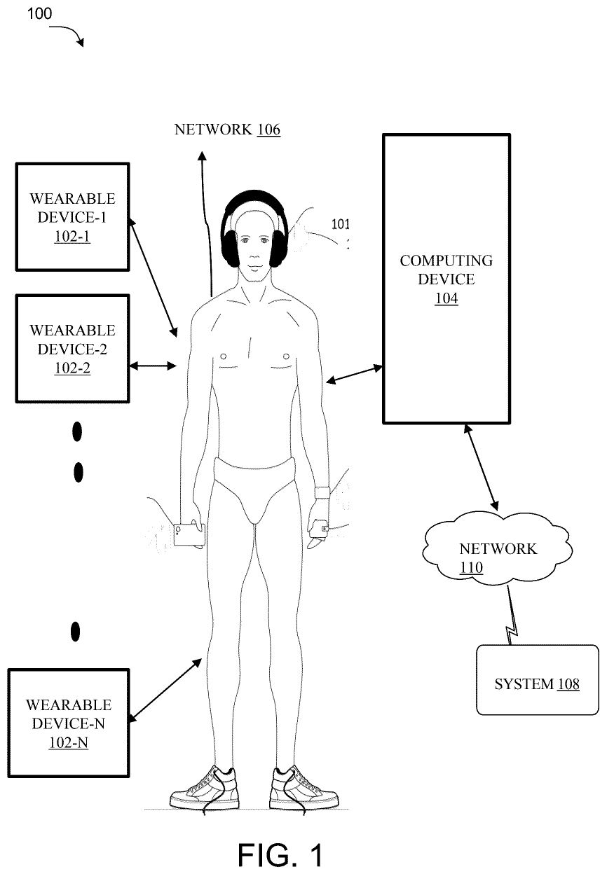

Referring now to the drawings, and more particularly to FIG. 1 through FIG. 6, where similar reference characters denote corresponding features consistently throughout the figures, there are shown preferred embodiments, and these embodiments are described in the context of the following exemplary system and/or method.

FIG. 1 illustrates an example network architecture for implementing a computing device 108 for enabling multimedia communication through human body as a medium, in accordance with an embodiment of the present disclosure.

As illustrated in FIG. 1, the network architecture 100 may include a system 108. The system 108 may be connected to one or more computing devices 104-1, 104-2 . . . 104-N via a network 110. Further, the system 108 may be connected to the one or more wearable devices 102-1-N via the network 110. Each of the one or more computing devices 104-1, 104-2 . . . 104-N (referred herein as one or more computing device 104) may be connected to the one or more wearable devices 102-1, 102-2 . . . 102-N. (referred herein as one or more wearable devices 102) via a network 106. In an example embodiment, the network 106 (may be referred to as conducive surface 106 or communication channel 106 or human body 106) may be a human body acting as a communication medium between multiple devices around the human body 101. The one or more computing devices 104-1, 104-2 . . . 104-N (referred herein as one or more computing device 104) may be operated by one or more users using one or more wearable devices 102-1, 102-2 . . . 102-N (referred herein as one or more wearable devices 102). The network 110 may be wired/wireless networks.

The system 108 may include, but is not limited to, a smartphone, a mobile phone, a personal digital assistant, a tablet computer, a tablet computer, a wearable device, a computer, a laptop computer, an augmented/virtual reality device (A/VR), internet of things (IoT) device, a camera, any other device, and the combination thereof. In an embodiment, the system 108 may be a remote server, web server, edge server, a cloud server or the like.

The one or more computing devices 104 may include, but is not limited to, a smartphone, a mobile phone, a personal digital assistant, a tablet computer, a tablet computer, a wearable device, a computer, a laptop computer, an augmented/virtual reality device (AR/VR), internet of things (IoT) device, a camera, any other device, and the combination thereof.

The one or more wearable devices 102 may be, for example, but not limited to, smartwatches, head-mounts, fitness trackers, smart glasses, and the like.

As illustrated in the figure, enabling multimedia communication through a human body as a communication network involves utilizing the human body as a medium for transmitting data signals, typically employing techniques such as Body Area Networks (BANs) or Human Body Communication (HBC). The human body conducts electrical signals naturally due to the presence of electrolytes in bodily fluids. The electrical signals may be utilized to transmit data. Data, such as audio, video, or sensor readings, may be modulated onto electrical signals. As shown in the FIG. 1, one or more wearable devices 102 may be integrated with a transmitter to encode the modulated data onto the electrical signals. The electrical signals may then be injected into the human body. In the human body, the electrical signals travel via conductive paths, primarily through tissues and fluids. On the receiving end, another device, which may be a computing device 104, detects and interprets the modulated signals from the human body. The received electrical signals are demodulated to extract original data. The demodulated data is then processed, decoded, and presented to the user. In an embodiment, the server, or the system 108 may act as a gateway between the one or more wearable devices 102 and external systems such as smartphones, computers, or cloud services.

In an embodiment, the system 108 may receive a request for transmitting a multimedia data file to a proximal device using a conductive surface. In an embodiment, the proximal device may be either one of the computing device 104 or any other wearable device 102. As used herein the “multimedia data file” may be a digital file containing multiple types of media, such as audio, video, images, and text, which may, in some instances, be integrated into a single document or presentation in formats such as MP3, MP4, JPEG, GIF, PDF, and more, depending on types of media. When transmitted over a wireless communication channel using the human body 106 as a medium, the multimedia data file is converted into electrical signals that may propagate through conductive tissues of the human body. The electrical signals represent digital information encoded in the multimedia data file. In an example embodiment, where a wearable device 102 is transmitting a multimedia stored in a digital file to another device worn by another person, or another device worn by the same person, the multimedia data file would be converted into electrical signals and transmitted through the body of a sender. The device of the receiver would then detect the electrical signals, decode the electrical signals back into the original multimedia data file, and present multimedia content to a user. In an exemplary embodiment, the conductive surface may include at least one of a human body, and a living matter. In an embodiment, the proximal device may include at least one of a wearable device 102, a handheld device, an augmented reality device, a computing device 104, or an ear-phone. The system 108 further generates EQS fields between the wearable device 102 and the conductive surface and between the conductive surface and the proximal device (such as for example, a computing device 104). The EQS fields are generated by applying a voltage on the wearable device 102. The EQS fields remain contained near the conductive surface and induce current in the proximal device 104. The system 108 may then create a communication channel for high-speed data transfer with the proximal device 104 using the generated EQS fields and determine communication properties of the conductive surface for transmission of the multimedia data file to the proximal device 104. As used herein, “communication properties” may be defined as conductivity of the surface, surface area to potentially accommodate more data streams simultaneously allowing for higher data transmission rates, a degree of signal attenuation of the conductive surface, available bandwidth of the conductive surface, propagation characteristics of signals on the conductive surface such as signal dispersion and reflection, and biocompatibility of the conductive surface. The communication properties may include at least one of a signal strength, a signal quality, a channel capacity, and a data rate.

In another embodiment, the system 108 convert the transmitted multimedia data file to an optimized multimedia data file by applying the determined communication properties to the transmitted multimedia data file. The system 108 transmits the optimized multimedia data file to the proximal device 104 via the conductive surface 106 using one or more communication techniques and one or more modulation schemes. The one or more communication techniques may include at least one of a pulse-based communication, spread-spectrum communication, carrier frequency hopping, time-domain communication, a digital communication and an analog communication and the like. In an embodiment, pulse-based communication refers to a method of transmitting information by encoding data into discrete pulses or short bursts of signals. In pulse-based communication systems, the presence or absence of pulses represents binary digits (bits), typically denoted as 1s and 0s, respectively. In an embodiment, the spread-spectrum communication may be a method of transmitting data in which signal is spread over a wide frequency band, typically much wider than the minimum bandwidth required for transmission. The spread-spectrum communication employs specific techniques to spread the signal across a wide frequency band. Two common techniques are frequency hopping spread spectrum (FHSS) and direct sequence spread spectrum (DSSS). In FHSS, carrier frequency rapidly changes according to a predetermined sequence, while in DSSS, each bit of the data is encoded using a spreading code that expands the bandwidth of the signal. In an embodiment, carrier frequency hopping is a technique used in spread-spectrum communication systems where the frequency of the carrier signal rapidly changes according to a predetermined sequence. This technique is typically employed in frequency hopping spread spectrum (FHSS) systems, which spread the transmitted signal's energy over a wide frequency band. In carrier frequency hopping, the transmitter and receiver in the communication system synchronize their carrier frequencies to hop or switch among different frequencies within a predefined frequency band. This hopping occurs at a high rate, typically several hundred or thousand hops per second. Time-domain communication refers to a method of transmitting data where information is encoded and decoded based on variations in the timing of signals. In time-domain communication systems, the timing characteristics of signals are the primary means of conveying information, as opposed to frequency-domain communication systems where the frequency characteristics of signals are utilized. Data is represented by variations in the timing of signal transitions, such as the timing of rising or falling edges of pulses. Different timing patterns or sequences correspond to different data symbols or bits. The one or more modulation schemes may include one of a single bit/symbol, a multi-bit/symbol comprising an orthogonal multiplexing, an amplitude modulation, a phase modulation, and a frequency modulation scheme. Orthogonal multiplexing refers to a method of combining multiple independent data streams into a single composite signal for transmission over a communication channel. In orthogonal multiplexing, each data stream is modulated using orthogonal functions or waveforms that are mathematically independent of each other. This ensures that individual data streams may be separated and recovered without interference at the receiver end. Amplitude modulation (AM) is a modulation technique used to encode information onto a carrier signal by varying its amplitude. In AM, amplitude of the carrier signal is modulated in proportion to the instantaneous amplitude of the modulating signal (also known as the baseband signal), which carries the information to be transmitted. Phase modulation (PM) is a modulation technique used to encode information onto a carrier signal by varying its phase. In PM, the phase of the carrier signal is modulated in response to the instantaneous phase of the modulating signal (baseband signal), which carries the information to be transmitted. Frequency modulation (FM) is a modulation technique used to encode information onto a carrier signal by varying its frequency. In FM, the frequency of the carrier signal is modulated in response to the instantaneous amplitude of the modulating signal (baseband signal), which carries the information to be transmitted.

The optimized multimedia data files may be transmitted over the created communication channel 106. As used herein, “optimized multimedia data files” refer to multimedia files that have been optimized or tailored to achieve specific objectives or requirements related to storage, transmission, processing, or playback performance. In converting the transmitted multimedia data file to the optimized multimedia data file, the system 108 may perform at least one of amplification of a signal strength of the transmitted multimedia data file to generate the optimized multimedia data file using at least one of a capacitive termination, a high impedance termination, an air gap termination, a non-100-Ohm termination in conjunction with the human body and amplification of a channel capacity of the created communication channel. The channel capacity may be improved by all the techniques mentioned with the signal strength along with techniques such as body resonance communication, using wideband, broadband communication to utilize more bandwidth.

Further, the system 108 may operate in a frequency range of 0.1-200 MHz using at least one of a broadband communication, a wideband communication and a narrowband communication. In an exemplary embodiment, the system 108 may be integrated partly or fully within the wearable device 102 and in such a case, the above-mentioned steps may be performed by the wearable device 102 itself.

Although FIG. 1 shows exemplary components of the network architecture 100, in other embodiments, the network architecture 100 may include fewer components, different components, differently arranged components, or additional functional components than depicted in FIG. 1. Additionally, or alternatively, one or more components of the network architecture 100 may perform functions described as being performed by one or more other components of the network architecture 100.

In an example working mode of operation, a person wearing a smartwatch (wearable device) may require sharing a high-resolution video (multimedia data file) with a nearby smartphone (proximal device) using their body as the conductive surface. The smartwatch may receive a request to transmit the video file. The smartwatch may convert the video file into a format suitable for EQS transmission (e.g., removing unnecessary headers or compressing the data). The smartwatch may further generate controlled EQS fields between the smartwatch and the conductive surface (e.g., the person's arm). Further, the smartwatch may generate the EQS fields between the conductive surface and the smartphone (e.g., touching the phone to the arm). These EQS fields are carefully shaped to stay close to the body, minimizing interference with other devices or the environment. The smartwatch analyzes the conductive surface properties (e.g., conductivity, size, shape) to determine the optimal parameters for data transmission. Based on this analysis, it creates a dedicated communication channel which is benefited by the presence of the human body or a conductive surface, within the EQS fields for high-speed data transfer between the smartwatch and the smartphone. The smartwatch applies the determined communication properties to the video file, essentially tailoring it for transmission through the specific characteristics of the EQS channel and the user's body. This optimization might involve one of adjusting the data rate based on the channel capacity, using specific modulation schemes suitable for EQS transmission, employing error correction techniques to ensure data integrity and the like. The optimized video file is then transmitted through the created communication channel using one or more communication techniques (e.g., amplitude or phase modulation) and modulation schemes. The smartphone's receiver picks up the EQS fields induced by the transmitted data. The smartphone then decodes the optimized video file based on the known communication parameters and modulation schemes. Finally, the smartphone processes the received data to reconstruct the original high-resolution video for viewing.

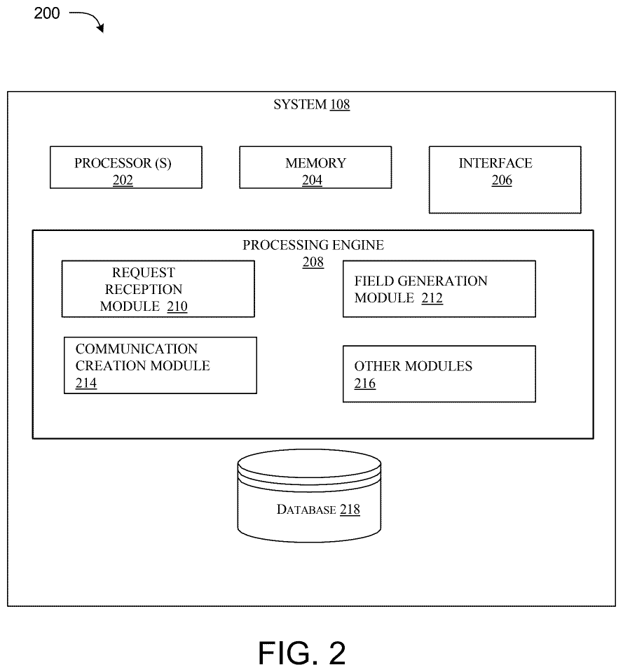

FIG. 2 illustrates an example block diagram of the system 108, such as those shown in FIG. 1, for enabling multimedia communication through the human body as a medium, in accordance with an embodiment of the present disclosure.

Referring to FIG. 2, the system 108 may comprise one or more processor(s) 202 that may be implemented as one or more microprocessors, microcomputers, microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the system 108. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as random-access memory (RAM), or non-volatile memory such as erasable programmable read only memory (EPROM), flash memory, and the like.

In an embodiment, the system 108 may include an interface(s) 206. The interface(s) 206 may comprise a variety of interfaces, for example, interfaces for data input and output (I/O) devices, storage devices, and the like. The interface(s) 206 may also provide a communication pathway for one or more components of the system 108. Examples of such components include, but are not limited to, processing engine(s) 208 and a database 218, where the processing engine(s) 208 may include, but not be limited to, a request reception module 210, a field generation module 212, a communication establishment module 214, and other module(s) 216.

In an embodiment, the processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor-executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 108 may comprise the machine-readable storage medium storing the instructions and the processing resource to execute the instructions, or the machine-readable storage medium may be separate but accessible to the system 108 and the processing resource. In other examples, the processing engine(s) 208 may be implemented by electronic circuitry.

In an embodiment, the request reception module 210 of the processor 202 may receive a request for transmitting the multimedia data file to a proximal device using a conductive surface.

In an embodiment, the field generation module 212 of the processor 202 may generate Electric Quasistatic (EQS) fields between the wearable device and the conductive surface and between the conductive surface and the proximal device. The conductive surface may include at least one of a human body and a living matter or a medium which aids the signal transmission and the proximal device may include at least one of a wearable device, a handheld device, an augmented reality device, and earphones. The EQS fields may remain contained near the conductive surface and induce current in the proximal device.

In an embodiment, the communication creation module 214 of the processor 202 may then create a communication channel for high-speed data transfer with the proximal device using the generated EQS fields and determine communication properties of the conductive surface for transmission of the multimedia data file to the proximal device. The communication properties include at least one of a signal strength, a signal quality, a channel capacity, and a data rate. Further, the transmitted multimedia data file may be converted to an optimized multimedia data file by applying the determined communication properties to the transmitted multimedia data file. Converting the transmitted multimedia data file to the optimized multimedia data file by applying the determined communication properties to the transmitted multimedia data file may include performing at least one of amplifying a signal strength of the transmitted multimedia data file to generate the optimized multimedia data file using at least one of a capacitive termination, a high impedance termination, an air gap termination, a non-100-Ohm termination in conjunction with the human body or a conductive surface, which aids the transmission and then amplifying a channel capacity of the created communication channel by the processor 202. Further, the processor 202 may transmit the optimized multimedia data file to the proximal device via the conductive surface using one or more communication techniques and one or more modulation schemes. The optimized multimedia data files are transmitted over the created communication channel. The one or more communication techniques includes at least one of a pulse-based communication, spread-spectrum communication, carrier frequency hopping, time-domain communication, a digital communication and an analog communication and the one or more modulation schemes comprise one of a single bit/symbol, a multi-bit/symbol comprising an orthogonal multiplexing, an amplitude modulation, a phase modulation, and a frequency modulation scheme. In an aspect, the wearable device operates in a frequency range of 0.1-200 MHz using at least one of a broadband communication, a wideband communication, and a narrowband communication.

Although FIG. 2 shows exemplary components of the system 108, in other embodiments, the system 108 may include fewer components, different components, differently arranged components, or additional functional components than depicted in FIG. 2. Additionally, or alternatively, one or more components of the system 108 may perform functions described as being performed by one or more other components of the system 108.

In an exemplary embodiment, the system 108 may be integrated partly or fully within the wearable device 102 and in such a case, the above-mentioned steps may be performed by the wearable device 102 itself. In such a case, the data processing, analysis, and other methods may be performed at the computing device 104. The wearable device 102 may be configured to stream the multimedia file to the computing device 104 via the network 106. The system 108 may display the video, or perform some computing on the video to obtain inference, or the system 108 could pass the video on to some far device using wireless communication.

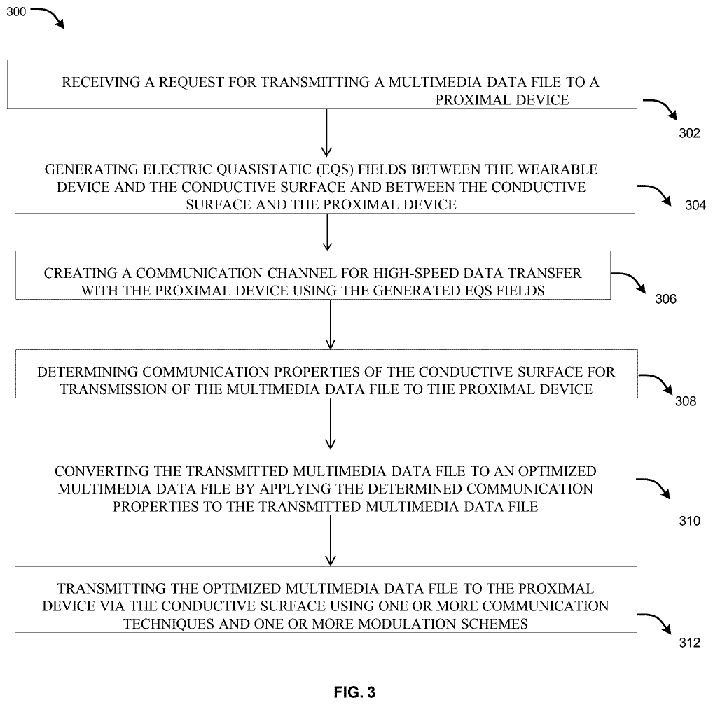

FIG. 3 illustrates an example flow diagram 300 of depicting a method for enabling multimedia communication through the human body as a medium, in accordance with an embodiment of the present disclosure.

At step 302, the method 300 includes, receiving, by the processor 202, a request for transmitting a multimedia data file to a proximal device using a conductive surface.

At step 304, the method 300 includes, generating, by the processor 202, EQS fields between the wearable device and the conductive surface and between the conductive surface and the proximal device, wherein the EQS fields remain contained near the conductive surface, and wherein the EQS fields induces current in the proximal device. The EQS fields may remain contained near the conductive surface and induce current in the proximal device.

At step 306, the method 300 includes creating, by the processor 202, a communication channel for high-speed data transfer with the proximal device using the generated EQS fields using techniques including but not limited to EQS-HBC, Body Resonance Communication.

At step 308, the method 300 includes, determining, by the processor 202, communication properties of the conductive surface for transmission of the multimedia data file to the proximal device. The conductive surface may include at least one of a human body and a living matter or a medium, which aids the signal transmission and the proximal device may include at least one of a wearable device, a handheld device, an augmented reality device, and earphones. The EQS fields may remain contained near the conductive surface and induce current in the proximal device.

At step 310, the method 300 includes, converting, by the processor 202, the transmitted multimedia data file to an optimized multimedia data file by applying the determined communication properties to the transmitted multimedia data file. In converting the transmitted multimedia data file to the optimized multimedia data file, the method 300 may include performing at least one of amplifying a signal strength of the transmitted multimedia data file to generate the optimized multimedia data file using at least one of a capacitive termination, a high impedance termination, an air gap termination, a non-100-Ohm termination in conjunction with the human body. Converting the transmitted multimedia data file to the optimized multimedia data file may further include amplifying a channel capacity of the created communication channel by the processor 202.

At step 312, the method 300 includes transmitting, by the processor 202, the optimized multimedia data file to the proximal device via the conductive surface using one or more communication techniques and one or more modulation schemes, wherein the optimized multimedia data files are transmitted over the created communication channel. The optimized multimedia data files are transmitted over the created communication channel. The communication properties include at least one signal strength, a signal quality, a channel capacity, and a data rate. The one or more communication techniques includes at least one of pulse-based communication, spread-spectrum communication, carrier frequency hopping, time-domain communication, digital communication, and an analog communication and the one or more modulation schemes comprise one of single bit/symbol, multi-bit/symbol comprising orthogonal multiplexing, amplitude modulation, phase modulation, and frequency modulation scheme and one or more communication methods such as EQS-HBC or Body Resonance Communication.

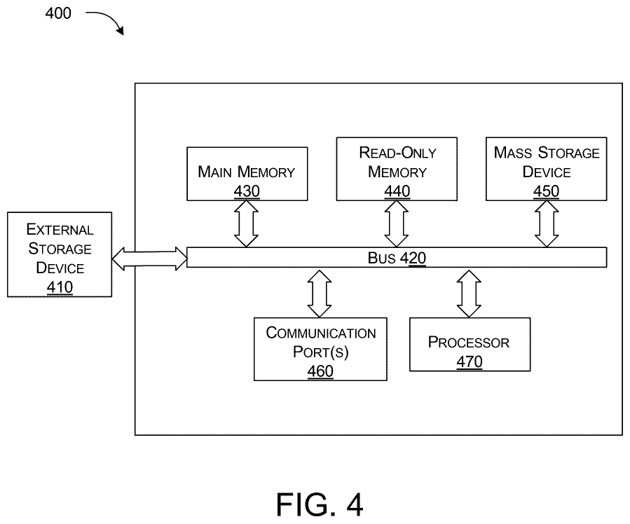

FIG. 4 illustrates an example computer system 400 in which or with which embodiments of the present disclosure may be implemented.

As shown in FIG. 4, the computer system 400 may include an external storage device 410, a bus 420, a main memory 430, a read-only memory 440, a mass storage device 450, a communication port(s) 460, and a processor 470. A person skilled in the art will appreciate that the computer system 400 may include more than one processor and communication ports. The processor 470 may include various modules associated with embodiments of the present disclosure. The communication port(s) 460 may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) 460 may be chosen depending on a network, such as a Local Area Network (LAN), Wide Area Network (WAN), or any network to which the computer system 400 connects.

In an embodiment, the main memory 430 may be Random Access Memory (RAM), or any other dynamic storage device commonly known in the art. The read-only memory 440 may be any static storage device(s) e.g., but not limited to, a Programmable Read Only Memory (PROM) chip for storing static information e.g., start-up or basic input/output system (BIOS) instructions for the processor 470. The mass storage device 450 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus 420 may communicatively couple the processor(s) 470 with the other memory, storage, and communication blocks. The bus 420 may be, e.g. a Peripheral Component Interconnect PCI)/PCI Extended (PCI-X) bus, Small Computer System Interface (SCSI), (USB), or the like, for connecting expansion cards, drives, and other subsystems as well as other buses, such a front side bus (FSB), which connects the processor 470 to the computer system 400.

In another embodiment, operator, and administrative interfaces, e.g., a display, keyboard, and cursor control device may also be coupled to the bus 420 to support direct operator interaction with the computer system 400. Other operator and administrative interfaces may be provided through network connections connected through the communication port(s) 460. Components described above are meant only to exemplify various possibilities. In no way should the aforementioned exemplary computer system 400 limit the scope of the present disclosure.

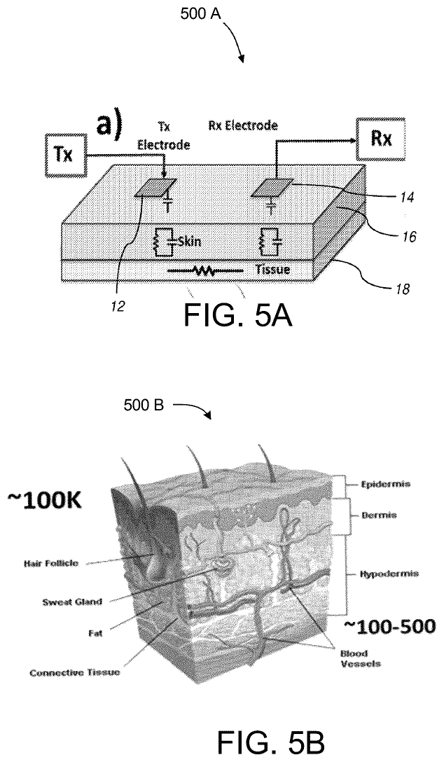

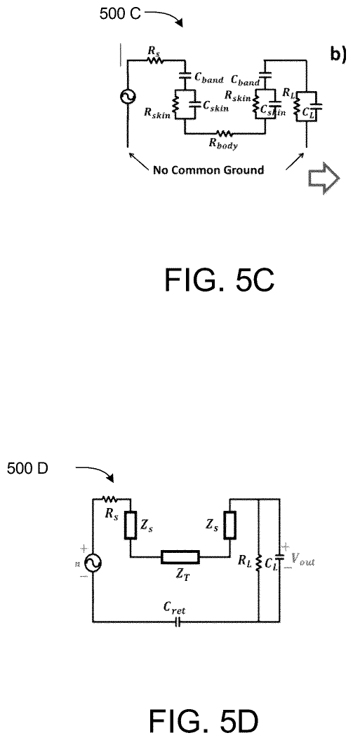

FIG. 5A-5D illustrate circuit diagram representations of human body acting as a communication medium for enabling multimedia or data communication between at least two devices, in accordance with an embodiment of the present disclosure. FIG. 5 is a detailed circuit diagram of the system 108 for enabling multimedia or data communication through the human body as a medium. The circuit diagram shows that there is no common ground, which is there is no closed path for current to flow. The closed path is formed using parasitic capacitances from the wearable device to the earth's ground (Cret). Depicted in the figure is a simplified lumped model of the system for enabling multimedia communication through the human body as a medium that may include one or more wearable devices. The human body may be used as a broadband (BB) channel for data transmission. The broadband channel with ˜MHz bandwidth may enable data transmission at megabits/second speed which is sufficient for applications such as image or data transfer. FIGS. 5A, 5B, 5C, and 5D represents the system 108 having a transmit electrode and a receive electrode adjacent or slightly separated from human skin with associated lower tissue. The figure shows a typical human skin and tissue anatomy. As illustrated, Zₛ represents a combination of a skin-electrode contact resistance and skin tissue resistance and is in the order of KΩ. Once a signal is coupled to the body the signal is transferred through low resistance tissue layers inside the body, whose impedance is modeled as Z_{T}. The source impedance (Rₛ) is of the order of few ohms. The load could consist of a parallel combination of resistance (R_{L}), capacitance (C_{L}). Since the summation of skin and tissue impedance is above the KΩ range, a 50Ω or other low-impedance termination at the receiver creates an unfavorable voltage division, leading to a high-loss at low frequencies. The load resistance should be chosen as a high impedance on the order of MΩs. Efficient communication in such a scenario is achieved by focusing on the voltage transfer characteristics of the human body channel. To that end, according to one embodiment, Voltage Mode (VM) Signaling is used for the communication between the devices in the system 108.

Since a summation of skin and tissue impedance is above the KΩ range, a 50Ω or other low impedance termination at the receiver creates an unfavorable voltage division, leading to a high loss at low frequencies. The load resistance should be chosen as a high impedance on order of MΩs (e.g., 1-10 M Ωs, 1-100 MΩs or 1-900 MΩs). Efficient communication in such a scenario is achieved by focusing on voltage transfer characteristics of human body channel. To that end, according to one embodiment, Voltage Mode (VM) Signaling may be used for communication between the wearable devices. In VM signaling, the measured metric at different points of the system 108 is voltage and voltage transmission is achieved by a low output impedance source and high input impedance load. Capacitive termination allows close to flat-band response, making it suitable for broadband signaling. A closed path is formed using parasitic capacitances from device I and 2 to the earth's ground (Cret). Capacitive termination (C_{L}) is used at the receiver end and provides a flat-band frequency response as shown by the loss equation below:

$$Channel Loss = \frac{Vrx}{Vtx} = \frac{Cret}{( Cret + CL )} \qquad equation ( 1 )$$

Since Channel Loss is not a function of frequency, the channel loss provides a flat band frequency response, suitable for broadband signaling, that has energy in a broad bandwidth from DC to operating frequency. A return path is formed by a capacitance between the transmitter and the receiver. Return path capacitance and the capacitance at the receiver end forms a capacitive voltage division. Since a capacitive voltage division ratio is independent of frequency, this results in a channel response with almost constant loss across all frequencies, resulting in a broadband channel. The broadband channel enables transmission of a signal through the human body directly as 1/0 bits without the need of any modulation or demodulation techniques. Since broadband human body channel enables maximum utilization of available bandwidth, systems utilizing the human body channel will be more power-efficient than previous narrowband wireless or HBC-based systems. The human body acts as an antenna and picks up interferences, which makes broadband communication through the body difficult. An integrating DDR (1-DDR) receiver may manage interferences with frequency f_{intf}=nf_{data} where n is a positive integer. Any other frequencies f_{intf}>f_{data} may be rejected by dynamically adjusting integration time according to Tᵢₙₜ=n*T_{intf} which shows that this technique works well for interferences higher than data-rate but does not provide much benefit for interference frequencies below data-rate.

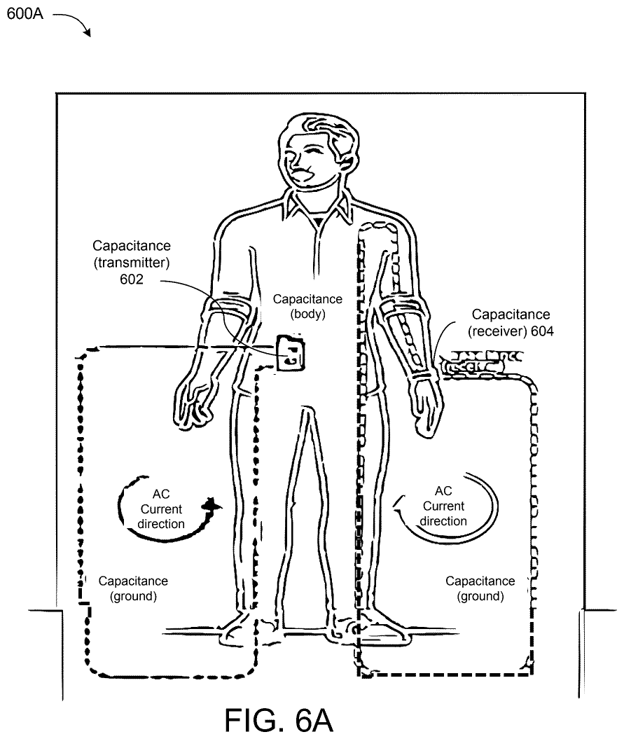

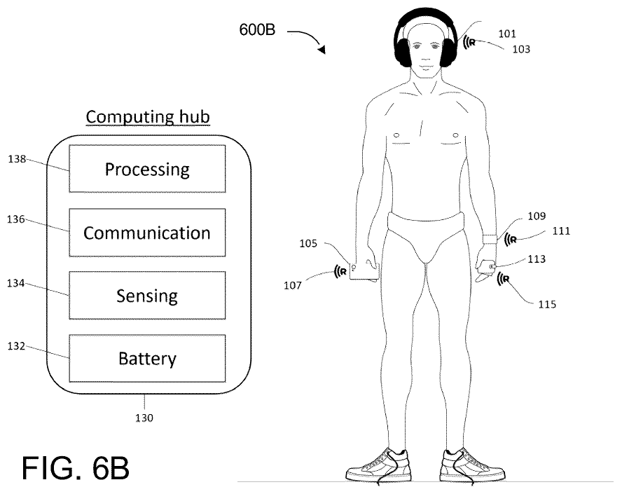

FIGS. 6A and 6B illustrates exemplary schematic representations 600A, 600B of a Human Body Aided Audio/Video Communication System, including transmitter and receiver configuration, in accordance with an embodiment of the present disclosure. As illustrated in the FIG. 6A-6B, the system 108 for enabling multimedia communication through the human body as a medium includes a transmitter and a receiver configured to maximize signal strength by utilizing properties of any living matter or conductive surface, thereby improving channel capacity and data rate. The system 108 applies different communication techniques, including pulse-based communication, spread-spectrum communication, carrier frequency hopping, time-domain communication, and digital or analog communication and various modulation schemes such as amplitude, phase, frequency modulation, or any combination of amplitude, phase, and frequency modulation. The system 108 is enabled to operate in a frequency range of 0.1-200 MHz, where communication signals are aided by the human body. The system may use a broadband communication (0.1-maximum frequency, e.g., 0.1-50 MHz or 0.1-30 MHz), wideband communication (e.g., 5-15 MHz or 10-30 MHz or 100-120 MHz or 150-200 MHz with a carrier frequency component), narrowband communication (e.g., 20.5-21.5 MHz with a carrier of 21 MHz), or pulse-based communication, where the dominant frequency components lie in the frequency range defined. The system 108 may also use digital or analog communication to represent audio/video signals or data signals, and the modulation scheme used may be single bit/symbol or multi-bit/symbol, including orthogonal multiplexing such as IQ modulation with multiple bits (including but not limited to BPSK, QPSK, 16QAM, 64QAM, 256QAM). The system may further use time-domain communication, where time-modulated signals are communicated around the human body representing audio/video or data. The Human Body Aided Audio/Video Communication System has many potential applications, including communication devices for noisy environments, hearing aids, wireless headphones, and augmented reality devices. The system 108 may be further configured to improve the quality of audio/video or data communication in various settings, allowing for clearer communication and improved user experiences.

In an embodiment, the methodology of sending signals directly through the human body is referred to as electro-quasistatic human-body communication which means that the human body serves as a body channel with conductive properties. An average adult human is about 60 percent water by weight. Pure water is a poor electrical conductor, but water filled with conductive particles like electrolytes and salts conducts electricity better. The body is filled with a watery solution called interstitial fluid that sits underneath the skin and around the cells of your body. The interstitial fluid is responsible for carrying nutrients from the bloodstream to the cells of the body, and is filled with proteins, salts, sugars, hormones, neurotransmitters, and all sorts of other molecules that help keep the body going. Because interstitial fluid is everywhere in the body, it allows the establishment of a circuit among two or more communicating devices anywhere on the body. The communicating devices, which may include the wearable device and the proximal device, may each be outfitted with a small copper electrode on the back, in direct contact with the skin. Each device may also have a second electrode not in contact with the skin and configured as a sort of floating ground, which is a local electrical ground that is not directly connected with Earth's ground. In an embodiment, the methodology of utilizing the resonant property of the human body to improve communication channel characteristics is known as Body Resonance Communication.

When the wearable device takes a measurement of any vital parameter of the human body, data pertaining to the measurement of any vital parameter of the human body is transmitted to the user and stored for long-term monitoring. The data may also be encrypted and sent to one or more devices of the user for remote storage and analysis. The data may be encoded into a series of voltage values that are transmitted by applying a voltage between two copper electrodes including the first copper electrode that is touching the human body, and the second copper electrode acting as a floating ground. The applied voltage causes a very slight change in potential of the entire body with respect to Earth's ground. The very slight change in potential between the body and Earth's ground is a fraction of the potential difference between the two electrodes, but is enough to be picked up, as an even smaller fraction after crossing the body, by the devices elsewhere. The wearable device may detect the change in potential across the first electrode and the second electrode. The potential measurements are then converted back into data, without the actual signal ever traveling beyond the skin. There is a range of frequencies at which the human body itself may become an antenna. An ordinary radio antenna creates a signal when an alternating current causes the electrons in the material to oscillate and create electromagnetic waves. The frequency of the transmitted waves depends on the frequency of the alternating current fed into the antenna. Likewise, an alternating current at certain frequencies applied to the human body will cause the body to radiate a signal. The signal, while weak, is still strong enough to be picked up with the right equipment and from a distance away. Frequencies in the range of 0.1 to 200 MHz of signals stay confined to the body. In an embodiment of the present disclosure, parasitic capacitance has been applied between the wearable device and the body to create a working channel. Capacitance refers to the ability of an object to store electrical charge. Parasitic capacitance is unwanted capacitance that occurs unintentionally between any two objects. If two charged areas are in proximity on a circuit board, or between a person's hand and their phone, parasitic capacitance comes into existence. A circuit needs to be a closed loop for electrical communication to be possible. In an embodiment, parasitic capacitance exists between the floating ground electrodes on the devices and Earth's ground creating the two circuit loops. The first loop of the two circuit loops begins with the transmitting device, at the electrode touching the skin. The circuit then goes through the body, down through the feet to the actual ground, and then back up through the air to the other (floating) electrode on the transmitting device. Even though this is not a loop through which direct current may flow, but because parasitic capacitances exist between any two objects, such as feet and shoes or shoes and the ground, a small alternating current may exist. The second loop of the two circuit loops, in a similar fashion, begins with the receiving device, at the electrode that is touching the skin. The small alternating current then goes through the body and the two circuit loops and back through the air to the floating-ground electrode on the receiving device. The two circuit loops are configured to push a current through a closed path of capacitors. In a circuit, if the voltage changes across one capacitor—for example, the two electrodes of the transmitting device-a slight alternating current in the loop is created. The other capacitors, meaning both the body and the air, see this current and, because of impedances, or resistances to the current, the voltages change as well. The circuit loop with the transmitting device and the circuit loop with the receiving device share the body as a segment of their respective loops. The receiving device also responds to the slight change in the voltage of the body. The two electrodes making up the capacitor of the receiving detect the changing voltage of the body and allow that measurement to be decoded as meaningful information.

One of the ordinary skills in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein may comprise hardware and software elements. The embodiments that are implemented in software include but are not limited to, firmware, resident software, microcode, a. The functions performed by various modules described herein may be implemented in other modules or combinations of other modules. For the purposes of this description, a computer-usable or computer-readable medium may be any apparatus that may comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, and the like, of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

What is claimed is:

1. A wearable device for communicating multimedia data comprising:
a processor; and
a memory coupled to the processor, wherein the memory comprises processor-executable instructions, which on execution, cause the processor to:
receive a request for transmitting a multimedia data file to a proximal device using a conductive surface;
generate Electric Quasistatic (EQS) fields between the wearable device and the conductive surface and between the conductive surface and the proximal device, wherein the EQS fields remain contained near the conductive surface, and wherein the EQS fields induce current in the proximal device;
create a communication channel for high-speed data transfer with the proximal device using the generated EQS fields;
determine communication properties of the conductive surface for transmission of the multimedia data file to the proximal device;
convert the transmitted multimedia data file to an optimized multimedia data file by applying the determined communication properties to the transmitted multimedia data file; and
transmit the optimized multimedia data file to the proximal device via the conductive surface using one or more communication techniques and one or more modulation schemes, wherein the optimized multimedia data files are transmitted over the created communication channel.

2. The wearable device of claim 1, wherein in converting the transmitted multimedia data file to the optimized multimedia data file by applying the determined communication properties to the transmitted multimedia data file, the processor is configured to:
perform at least one of:
amplify a signal strength of the transmitted multimedia data file to generate the optimized multimedia data file using at least one of a capacitive termination, a high impedance termination, an air gap termination, a non-100-Ohm termination in conjunction with one of a human body, a conductive surface and medium aiding signal transmission; and
amplify the channel capacity of the created communication channel using techniques comprising at least one of a body resonance communication, a wideband, and a broadband communication.

3. The wearable device of claim 1, wherein the conductive surface comprises at least one of a human body, and a living matter or a medium, aiding signal transmission.

4. The wearable device of claim 1, wherein the proximal device comprises at least one of a wearable device, a handheld device, an augmented reality device, and an ear-phones.

5. The wearable device of claim 1, wherein the communication properties comprise at least one of a signal strength, a signal quality, a channel capacity, and a data rate.

6. The wearable device of claim 1, wherein the one or more communication techniques comprise at least one of a pulse-based communication, spread-spectrum communication, carrier frequency hopping, time-domain communication, a digital communication, and an analog communication.

7. The wearable device of claim 1, wherein the wearable device operates in a frequency range of 0.1-200 MHz or more using at least one of a broadband communication, a wideband communication, and a narrowband communication.

8. The wearable device of claim 1, wherein the one or more modulation schemes comprise one of a single bit/symbol, a multi-bit/symbol comprising an orthogonal multiplexing, an amplitude modulation, a phase modulation, and a frequency modulation scheme.

9. A method for communicating multimedia data comprising:
receiving, by a processor, a request for transmitting a multimedia data file to a proximal device using a conductive surface;
generating, by the processor, Electric Quasistatic (EQS) fields between the wearable device and the conductive surface and between the conductive surface and the proximal device, wherein the EQS fields remain contained near the conductive surface, and wherein the EQS fields induces current in the proximal device;
creating, by the processor, a communication channel for high-speed data transfer with the proximal device using the generated EQS fields;
determining, by the processor, communication properties of the conductive surface for transmission of the multimedia data file to the proximal device;
converting, by the processor, the transmitted multimedia data file to an optimized multimedia data file by applying the determined communication properties to the transmitted multimedia data file; and
transmitting, by the processor, the optimized multimedia data file to the proximal device via the conductive surface using one or more communication techniques and one or more modulation schemes, wherein the optimized multimedia data files are transmitted over the created communication channel.

10. The method of claim 9, wherein converting the transmitted multimedia data file to the optimized multimedia data file by applying the determined communication properties to the transmitted multimedia data file comprises:
performing at least one of:
amplifying a signal strength of the transmitted multimedia data file to generate the optimized multimedia data file using at least one of a capacitive termination, a high impedance termination, an air gap termination, a non-100-Ohm termination in conjunction with the human body; and
amplifying a channel capacity of the created communication channel using techniques comprising one of a body resonance communication, a wideband, and a broadband communication.

11. The method of claim 9, wherein the conductive surface comprises at least one of a human body, and a living matter.

12. The method of claim 9, wherein the proximal device comprises at least one of a wearable device, a handheld device, an augmented reality device, and an earphones.

13. The method of claim 9, wherein the communication properties comprise at least one of a signal strength, a signal quality, a channel capacity, and a data rate.

14. The method of claim 9, wherein the one or more communication techniques comprise at least one of a pulse-based communication, spread-spectrum communication, carrier frequency hopping, time-domain communication, digital and an analog communication.

15. The method of claim 9, wherein the wearable device operates in a frequency range of 0.1-200 MHz or more using at least one of a broadband communication, a wideband communication, and a narrowband communication.

16. The method of claim 9, wherein the one or more modulation schemes comprise one of a single bit/symbol, a multi-bit/symbol comprising an orthogonal multiplexing, an amplitude modulation, a phase modulation, and a frequency modulation scheme.

17. The method of claim 9, wherein the multimedia data file is transmitted from a first wearable device to a second wearable device via a conductive surface aiding signal transmission.

18. The method of claim 9, wherein the transmitted multimedia data file is converted to an optimized multimedia file using one or more communication properties of the conductive surface and the optimized multimedia file is forwarded to the second wearable device, wherein the one or more communication properties comprises a signal strength, a signal quality, a channel capacity, and a data rate, and wherein the conductive surface comprises at least one of a human body, and a living matter or a medium aiding signal transmission.

19. The method of claim 18, wherein the second wearable device is communicatively coupled to the first wearable device via the conductive surface, wherein the optimized multimedia file is received by the second wearable device.

20. A non-transitory computer-readable medium comprising machine-readable instructions that are executable by a processor to:
receive a request for transmitting a multimedia data file to a proximal device using a conductive surface aiding signal transmission;
generate Electric Quasistatic (EQS) fields between the wearable device and the conductive surface and between the conductive surface and the proximal device, wherein the EQS fields remain contained near the conductive surface, and wherein the EQS fields induces current in the proximal device;
create a communication channel for high-speed data transfer with the proximal device using the generated EQS fields;
determine communication properties of the conductive surface for transmission of the multimedia data file to the proximal device;
convert the transmitted multimedia data file to an optimized multimedia data file by applying the determined communication properties to the transmitted multimedia data file; and
transmit the optimized multimedia data file to the proximal device via the conductive surface using one or more communication techniques and one or more modulation schemes, wherein the optimized multimedia data files are transmitted over the created communication channel.
